(19) United States
(12) Patent Application Publication
(10) Pub. No.: US 2002/0003681 A1
(43) Pub. Date: Jan. 10, 2002

(54) RECORDING/REPRODUCING APPARATUS WITH A RECORDING MEDIUM BETWEEN A FLOATING AND A DUMMY SLIDER

(76) Inventor: TOSHIHIKO TAKEGAWA, MIYAGI (JP)

Correspondence Address: CHARLES P SAMMUT, LIMBACH & LIMBACH, 2001 FERRY BUILDING, SAN FRANCISCO, CA, 94111

(21) Appl. No.: 09/103,433

(22) Filed: Jun. 24, 1998

(30) Foreign Application Priority Data
Jun. 30, 1997 (JP) P09-174799

(51) Int. Cl. G11B 5/48

(52) U.S. Cl. 360/244

(57) ABSTRACT

A magnetic recording/reproducing apparatus capable of recording or reproducing signals satisfactorily for a thin type disc-shaped recording medium. The magnetic recording/reproducing apparatus 10 includes a disc-shaped recording medium 1 having a recording layer formed on one major surface of a resin substrate, a floating slider 11 carrying a magnetic head and arranged facing the major surface of the disc-shaped recording medium having the recording layer and a dummy slider 12 arranged facing the opposite side major surface of the disc-shaped recording medium so that the dummy slider faces the floating slider 11 with the disc-shaped recording medium 1 in-between.

### BACKGROUND OF THE INVENTION

1. Field of the Invention

This invention relates to a recording/reproducing apparatus for a single-side disc-shaped recording medium having information signals recorded/reproduced on one major surface of a resin substrate thereof, that is having on one of the major surfaces of the resin substrate a recording layer, such as a magnetic recording layer by magnetic recording/reproduction or an optical recording layer by recording or reproduction by light.

The present invention is hereinafter explained with reference to an embodiment of a magnetic recording/reproducing apparatus having a magnetic recording layer on the disc-shaped recording medium.

2. Related Art

Among the disc-shaped recording mediums, there is known such a recording medium having a magnetic layer formed on a substrate of glass or non-magnetic metal. Among disc-shaped recording mediums, there is such medium the substrate of which is formed of inexpensive resin having excellent moldability or machinability. In particular, there is such a disc-shaped recording medium having a resin substrate and servo pits pre-formed as crests and valleys in its magnetic layer.

The disc-shaped recording medium is classified into a double side type in which information signals are recorded/reproduced on its both surfaces, and a single surface type in which information signals are recorded/reproduced on one of its both surfaces. With the single side type disc-shaped recording medium, it is possible to improve production yield and to reduce the number of component parts of the disc-shaped recording medium device or the number of assembling steps or steps of controlling the component parts. In addition, the single side disc-shaped recording medium, in which information signals are recorded/reproduced on only one side, is effective in designing a thin type magnetic recording/reproducing apparatus.

This type of the disc-shaped recording medium is loaded on the magnetic recording/reproducing apparatus for recording/reproducing information signals. This magnetic recording/reproducing apparatus, on which is loaded a disc-shaped recording medium, includes a floating slider carrying a magnetic head. In this magnetic recording/reproducing apparatus, a floating slider is arranged facing the magnetic layer when the disc-shaped recording medium is loaded thereon.

In this magnetic recording/reproducing apparatus, a disc-shaped recording medium is run in rotation at a pre-set speed. This floats the floating slider a pre-set distance from the disc-shaped recording medium. The floating slider carries a magnetic head which records or reproduces signals for the disc-shaped recording medium.

The conventional disc-shaped recording medium has a thickness of 1.2 mm. If this disc-shaped recording medium is used for manufacturing a removable magnetic recording medium, termed a removable disc, the recording medium including a cartridge enclosing it has a thickness of 7 to 10 mm. The present-day tendency is towards a thinner removable disc and a demand is raised to reduce the thickness of the disc-shaped recording medium itself.

However, if the conventional disc-shaped recording medium is reduced in thickness, the facing state thereof to the floating slider is not optimum. With the disc-shaped recording medium, the spacing between the magnetic head and the signal recording surface needs to be of a constant value at all times in the loaded state on the recording/reproducing apparatus. However, if, with the conventional single surface type disc-shaped recording medium, having an outside diameter of 3.5 inch, the above thickness is not larger than 1.2 mm, the maximum flexure is increased. On the other hand, if the thickness of the disc-shaped recording medium, with an outside diameter of 2.5 inch, the above thickness is not larger than 0.9 mm, as shown in FIG. 2, the maximum flexure is increased.

The maximum flexure herein means the amount of flexure the disc-shaped recording medium undergoes when a static load of approximately 3 gf is applied on the outer rim of the disc-shaped recording medium.

Thus, with the conventional disc-shaped recording medium, if it is reduced in thickness beyond a pre-set value, the maximum flexure is increased. Consequently, with the conventional disc-shaped recording medium, the spacing between the floating slider and the signal recording surface is not constant such that the floating slider carrying the magnetic head cannot be floated in stability. That is, the disc-shaped recording medium has a drawback that, if the disc-shaped recording medium, reduced in thickness, is loaded on a conventional magnetic recording/reproducing apparatus, information signals cannot be recorded/reproduced satisfactorily.

### SUMMARY OF THE INVENTION

It is an object of the present invention to provide a magnetic recording/reproducing apparatus whereby information signals can be recorded or reproduced satisfactorily for a disc-shaped recording medium reduced in thickness.

The present invention provides a recording/reproducing apparatus including a disc-shaped recording medium having a recording layer formed on one major surface of a resin substrate, a floating slider arranged facing the major surface of the disc-shaped recording medium having the recording layer and a dummy slider arranged facing the opposite side major surface of the disc-shaped recording medium so that dummy slider faces the floating slider with the disc-shaped recording medium in-between. The magnetic head is loaded on the floating slider.

With the magnetic recording/reproducing apparatus according to the present invention, the disc-shaped recording medium is clinched between the floating slider and the dummy slider from the vertical direction for signal recording/reproduction.

If there is not provided the dummy slider in this magnetic recording/reproducing apparatus, there is applied a load on the disc-shaped recording medium in a direction of thrusting the disc-shaped recording medium from the floating slider. This load significantly flexes the disc-shaped recording medium.

Conversely, with the magnetic recording/reproducing apparatus of the present invention, the thrusting load is applied to the disc-shaped recording medium not only from the floating slider but also from the dummy slider. Since the floating slider and the dummy slider are mounted facing each other in the magnetic recording/reproducing apparatus, the load produced from the side of the floating slider and that from the side of the dummy slider cancel each other so that the disc-shaped recording medium can be rotated satisfactorily without undergoing significant flexure.

Specifically, since the floating slider and the dummy slider are mounted facing each other with the disc-shaped recording medium in-between, a uniform load is applied to the rotating disc-shaped recording medium from its upper and lower sides. Thus, with the present magnetic recording/reproducing apparatus, optimum recording/reproduction may be realized without significantly flexing the thin type disc-shaped recording medium having a thickness of 0.5 to 1.2 mm and the radius of curvature of not less than 20 m.

### BRIEF DESCRIPTION OF THE DRAWINGS

FIG. 1 is a graph showing the relation between the thickness and the maximum flexure of a conventional 3.5 inch disc-shaped magnetic recording medium.

FIG. 2 is a graph showing the relation between the thickness and the maximum flexure of a conventional 2.5 inch disc-shaped magnetic recording medium.

FIG. 3 is a schematic perspective view for defining the maximum flexure.

FIG. 4 is a schematic longitudinally cross-sectional view of a disc-shaped recording medium.

FIG. 5 is a plan view showing an illustrative disc-shaped recording medium.

FIG. 6 is a schematic view for illustrating the definition of the radius of curvature.

FIG. 7 is a perspective view of the magnetic recording/reproducing apparatus according to the present invention.

FIG. 8 is a schematic view showing the structure of a magnetic recording/reproducing apparatus according to the present invention.

FIG. 9 is an exploded perspective view for illustrating the mounting of the disc-shaped recording medium.

FIG. 10 is a perspective view of a floating slider.

FIG. 11 is a perspective view of a dummy slider.

FIG. 12 is a graph showing the relation between the position of floating slider and the maximum flexure in case the floating slider and the dummy slider are offset 1.0 mm in the radial direction.

FIG. 13 is a graph showing measured size of the surface of the disc-shaped recording medium.

### DESCRIPTION OF PREFERRED EMBODIMENTS

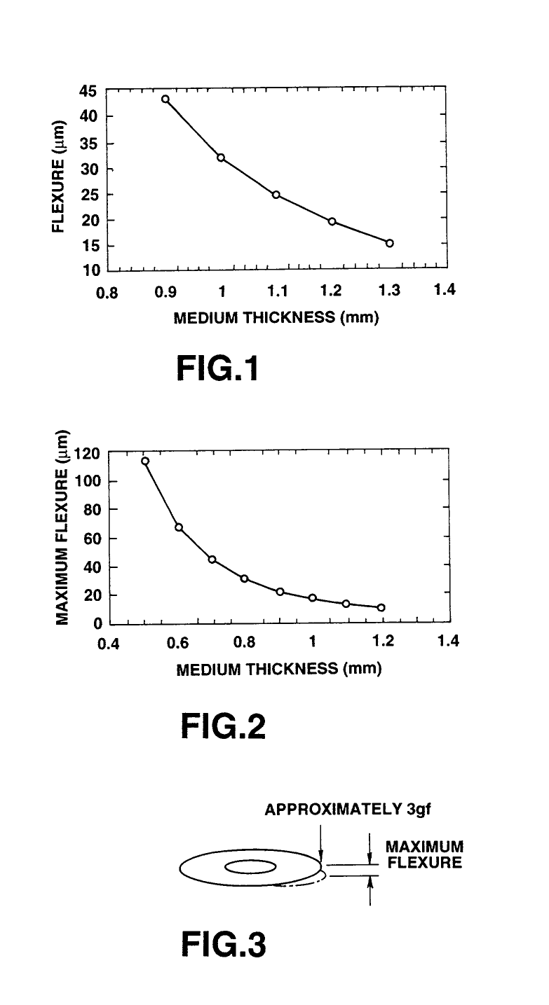

Referring to the drawings, preferred embodiments of a recording/reproducing apparatus according to the present invention will be explained in detail. This magnetic recording/reproducing apparatus is configured for recording/reproducing signals for a disc-shaped recording medium 1 shown in FIG. 1.

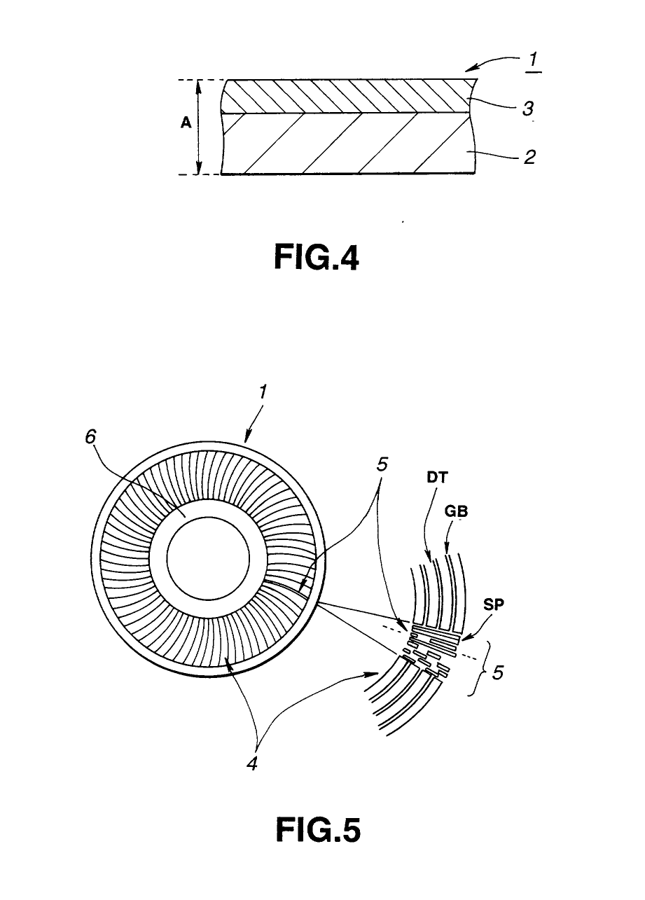

The disc-shaped recording medium 1 includes a substrate 2 of resin on one major surface of which is formed a magnetic layer 3, as shown in FIG. 4. The substrate 2 is of a synthetic resin exemplified by polycarbonate or polyolefin resin. By using this resin, the production yield can be improved, while the number of component parts or the number of assembling steps or that of the control steps of controlling the component parts can be reduced. In addition, the use of this type of resin for the substrate 2 leads to reduction in thickness of the magnetic recording/reproducing apparatus carrying the disc-shaped recording medium.

There is no particular limitation to the type of the material of the magnetic layer 3 which may be a cobalt-based alloy exemplified by CoPt based alloys or CoCr based alloys. In the disc-shaped recording medium 1, an underlayer formed of a Co-based alloy or a Cr-based alloy may be provided between the substrate 2 and the magnetic layer 3.

This disc-shaped recording medium 1 includes a data zone 4, in which to record the information, a servo zone 5 in which to record control signals, and a supporting clamp 6 on the radially inner side thereof, as shown in FIG. 5. With this disc-shaped recording medium 1, information signals are recorded/reproduced in the data zone 4 by a magnetic head carried on a floating slider.

In the data zone 4 are formed lands and recesses in concentric rings. On the lands of the data zone 4 are formed data tracks DT for recording data and so forth, as shown in FIG. 5. In the recesses of the data zone 4 are formed guard bands GB for separating neighboring data tracks DT.

In the data zone 5, there is formed a servo pattern SP such as the grey code for specifying the data track DT, clock marks as reference in generating servo clocks or wobbled marks used in tracking-controlling the magnetic head, on the lands or recesses.

Meanwhile, it suffices if the shape of the lands and recesses in the data zone 4 of the disc-shaped recording medium 1 is parallel to the running direction of the floating slider as later explained. Thus, it may be spiral. In addition, it may be continuous or interrupted to such an extent as not to affect the running of the floating slider. The data zone 4 may also be a mirror substrate devoid of lands or recesses.

The entire thickness of the disc-shaped recording medium 1, inclusive of the substrate 2 and the magnetic layer 3, indicated A in FIG. 4, is 0.5 to 1.2 mm. Also, the disc-shaped recording medium 1 has a radius of curvature not less than 20 m.

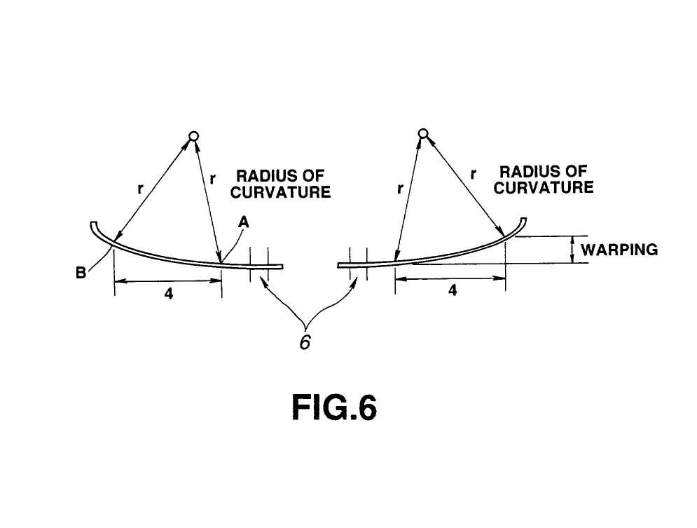

The radius of curvature herein means the radius of an arc when an area defined between the inner rim side shown at A in FIG. 6 and the outer rim side shown at B in FIG. 6 is thought of as being an arc in the data zone 4 of the disc-shaped recording medium 1.

Thus, by setting the radius of curvature to not less than 20 m as described above, it is possible with the disc-shaped recording medium to realize optimum recording/reproduction by the magnetic recording/reproduction as later explained, even with the thickness of 0.5 to 1.2 mm.

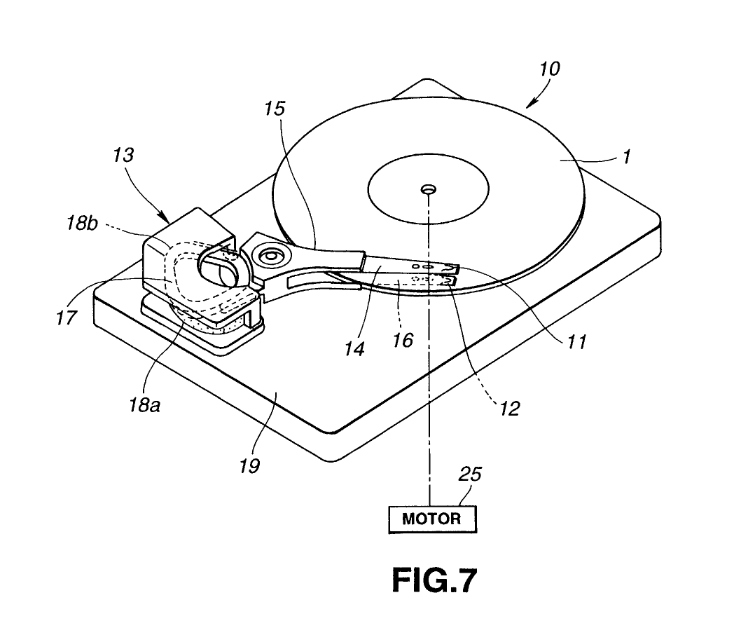

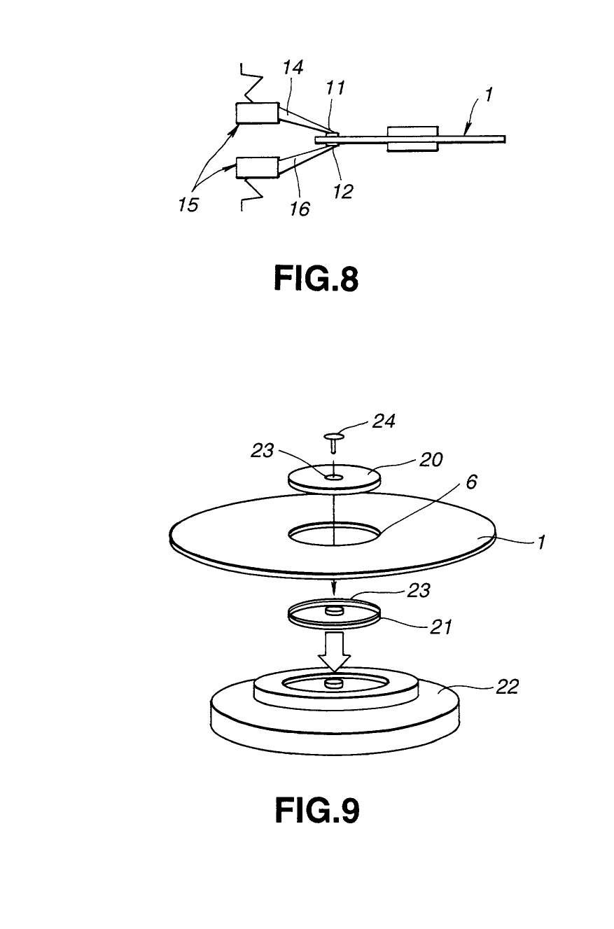

On the magnetic recording/reproducing apparatus according to the present invention is loaded the above-described disc-shaped recording medium for which signals are recorded and/or reproduced. If the recording medium is of the single side type, the magnetic recording/reproducing apparatus 10 includes a floating slider 11, positioned facing the magnetic layer 3 of the disc-shaped recording medium 1, and a dummy slider 12 positioned facing the floating slider 11, with the disc-shaped recording medium 1 in-between, as shown in FIGS. 7 and 8. The magnetic recording/reproducing apparatus 10 also includes a voice coil motor 13 for driving the floating slider 11 and the dummy slider 12. On the floating slider 11 is loaded a magnetic head, not shown in FIGS. 7 and 8, for recording/reproducing information signals for the disc-shaped recording medium 1.

In the present magnetic recording/reproducing apparatus 10, the floating slider 11 is connected to an arm 15 via a suspension 14. The dummy slider 12 is connected to the arm via a suspension 16.

On this arm 15 is mounted a voice coil 17 around which magnets 18a, 18b are arranged so that the voice coil 17 constitutes the voice coil motor 13 in cooperation with these magnets 18a, 18b.

In this magnetic recording/reproducing apparatus 10, the floating slider 11 and the dummy slider 12 are mounted on a base block 19 in a state in which the floating slider 11 and the dummy slider 12 are carried for oscillation by the voice coil motor 13. On this base block 19 is mounted the disc-shaped recording medium 1, as shown in FIG. 9.

For mounting the disc-shaped recording medium 1, the supporting clamp 6 is clinched between an upper damper 20 and a lower damper 21. In this state, the recording medium is mounted on the base block 19. The disc-shaped recording medium 1 is mounted on the spindle motor 22 by tightening a set screw 24 in tapped holes 23 formed substantially at the center of the upper damper 20 and the lower damper 21.

To this spindle motor 11 is connected a motor 25 run in rotation at a constant angular velocity.

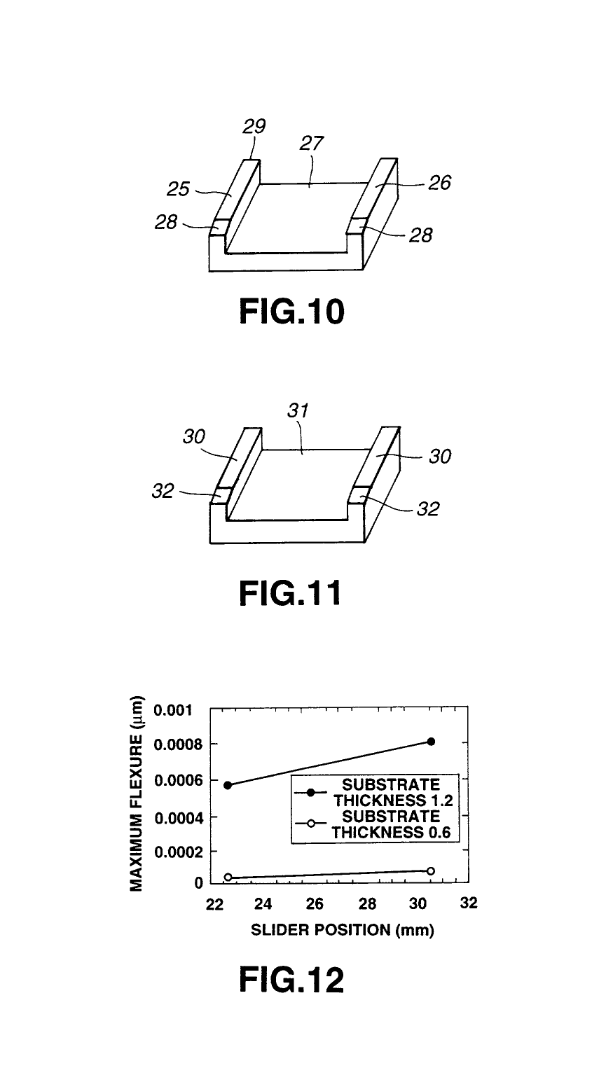

In the magnetic recording/reproducing 10, the floating slider 11 has a pair of side rails 26 on both lateral edges of its surface facing the magnetic layer 3 of the disc-shaped recording medium 1, and a recess 27 defined between the side rails 26, as shown in FIG. 10. The side rails 26 constitute an air bearing with respect to the disc-shaped recording medium 1. The side rails 26 run substantially parallel to recording track forming portion on the surface of the disc-shaped recording medium 1 when the floating slider 11 is positioned facing the disc-shaped recording medium 1. The air inlet side ends of the side rails 26 of the floating slider 11, on the forward side in the running direction of the disc-shaped recording medium 1, are formed with tapered portions 28. On the air outlet side end of the floating slider 11 is mounted a magnetic head 29.

In the present magnetic recording/reproducing apparatus 10, the dummy slider 12 is configured similarly to the floating slider 11 except that it is not provided with the magnetic head 29 or is provided with a magnetic head not having the recording/reproducing function. That is, the dummy slider 12 includes a pair of side rails 30 on both sides of its surface facing the substrate 2 of the disc-shaped recording medium 1, and a recess 31 defined between these side rails 30, as shown in FIG. 11. The side rails 30 of the dummy slider 12 are tapered at 32.

With the above-described magnetic recording/reproducing apparatus 10, the disc-shaped recording medium 1 is run in rotation at a constant angular velocity for recording/reproducing signals by a magnetic head, not shown.

The above-described disc-shaped recording medium 1 has a thickness of 0.5 to 1.2 mm and a radius of curvature not less than 20 m. When loaded on the above-described magnetic recording/reproducing apparatus 10, the disc-shaped recording medium 1 is clinched between the floating slider 11 and the dummy slider 12. At this time, the floating slider 11 and the dummy slider 12 may be in contact or out of contact with the major surfaces of the disc-shaped recording medium 1.

With the present magnetic recording/reproducing apparatus 1, there is induced air flow between the floating slider 11 and one of the major surfaces of the recording medium and between the dummy slider 12 and the opposite side major surface of the recording medium, as a result of rotation of the disc-shaped recording medium 1. That is, in the floating slider 11 and the dummy slider 12, air flows into the space between the side rails 26, 30 and the disc-shaped recording medium 1 to flow into the recesses 27, 31 to generate the floating force. Thus, with the present magnetic recording/reproducing apparatus 10, the floating slider 11 and the dummy slider 12 are floated at a separation of approximately 50 nm from the surfaces of the disc-shaped recording medium 1.

With the magnetic recording/reproducing apparatus 10, since the floating slider 11 is floated from the surface of the disc-shaped recording medium 1, the magnetic head 29 mounted on the floating slider 11 is floated from the surface of the disc-shaped recording medium 1 so as to be moved radially along with the floating slider 11, in a manner free of contact from the disc-shaped recording medium 1, whilst the same floating distance as that of the floating slider 11 is maintained from the disc-shaped recording medium 1. At this time, the dummy slider 12, mounted on the arm 15 carrying the floating slider 11, is moved radially in unison with the floating slider 11. That is, with this magnetic recording/reproducing apparatus 10, the floating slider 11 and the dummy slider 12 are perpetually arranged facing each other with the disc-shaped recording medium in-between.

Since the floating slider 11 and the dummy slider 12 in the magnetic recording/reproducing apparatus 10 are substantially of the same shape and weight, substantially the same floating force is applied to the floating slider 11 and to the dummy slider 12. Stated differently, approximately equal loads are applied from both surfaces of the disc-shaped recording medium 1. Thus, it is possible for the disc-shaped recording medium 1 to maintain planarity without being flexed in either directions. Therefore, with the present magnetic recording/reproducing apparatus 10, the magnetic head 29 loaded on the floating slider can be maintained at all times at a constant separation from the magnetic layer 3 to enable optimum recording/reproduction.

In the magnetic recording/reproducing apparatus 10, there are occasions wherein the floating slider 11 and the dummy slider 12 are not correctly facing each other via the disc-shaped recording medium. Specifically, there are occasions wherein, in the magnetic recording/reproducing apparatus, the floating slider 11 and the dummy slider 12 are radially offset from each other by approximately 1.0 mm.

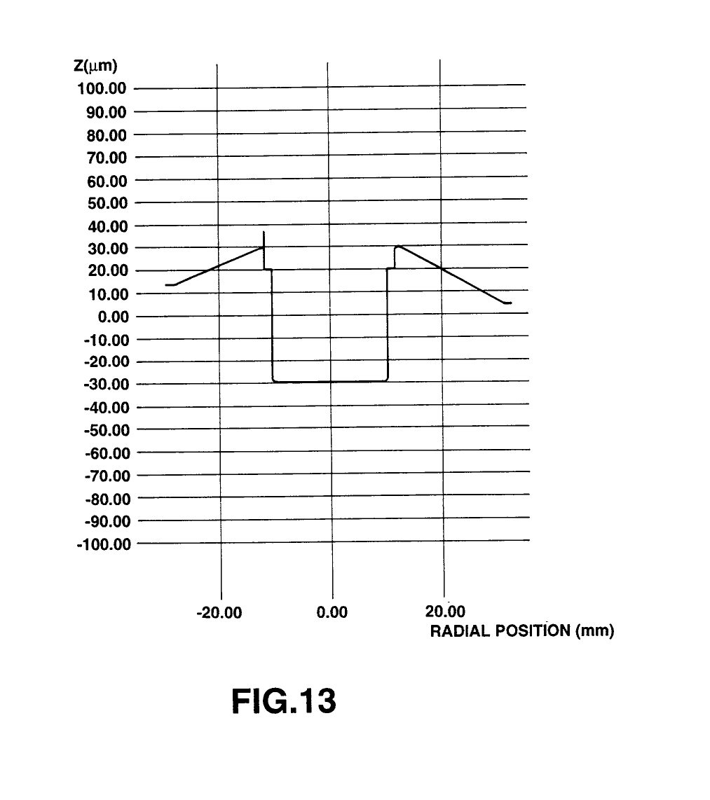

It is however possible with the present magnetic recording/reproducing apparatus 10 to suppress the flexure to not more than 0.001. Specifically, a disc-shaped recording medium, having an outer diameter of 2.5 inch and a thickness of 1.2 mm, and another disc-shaped recording medium, having an outer diameter of 2.5 inch and a thickness of 0.5 mm, were readied, and placed under a load of approximately 3 gf in order to calculate the maximum flexure by computer simulation. The results are shown in FIG. 12. Meanwhile, measured surface size and shape of a disc-shaped recording medium, having an outer diameter of 2.5 inch and a thickness of 0.5 mm, are shown in FIG. 13.

In FIG. 12, the positions of the floating slider 11 and the dummy slider 12 from the inner rim of the disc and the maximum flexure are plotted on the abscissa and on the ordinate, respectively. Thus, with the magnetic recording/reproducing apparatus 10, the maximum flexure can be suppressed to not larger than 0.001 because the radius of curvature of the disc-shaped recording medium is not less than 20 m even although the disc-shaped recording medium has a thickness of 0.5 mm to 1.2 mm.

The disc-shaped recording medium 1 according to the present invention, as described above, is reduced in thickness and can record/reproduce signals satisfactorily by having the thickness of 0.5 mm to 1.2 mm and the radius of curvature of not less than 20 m.

In the above-described disc-shaped recording medium 10, the disc-shaped recording medium is rotatably mounted at all times on the spindle motor 22. The magnetic recording/reproducing apparatus according to the present invention is, however, not limited to this configuration, and may be designed so that the disc-shaped recording medium is detachably mounted thereon. In this case, the disc-shaped recording medium according to the present invention is preferably accommodated in a cartridge formed of resin. The cartridge having the disc-shaped recording medium accommodated therein is mounted on or dismounted from the magnetic recording/reproducing apparatus.

In this case, in the magnetic recording/reproducing apparatus according to the present invention, the supporting clamp 6 of the disc-shaped recording medium housed in the cartridge is checked to permit rotation of the disc-shaped recording medium, and signals are recorded/reproduced for the disc-shaped recording medium in the same manner as in the above-described magnetic recording/reproducing apparatus 10.

Thus, with the present disc-shaped recording medium, the thickness thereof can be set to 0.5 mm to 1.2 mm by setting its radius of curvature to not less than 20 m. Therefore, the present disc-shaped recording medium can be used with advantage to a thin type removable disc.

What is claimed is:

1. A recording/reproducing apparatus comprising:
a disc-shaped recording medium having a recording layer formed on one major surface of a resin substrate;
a floating slider arranged facing the major surface of the disc-shaped recording medium having the recording layer, said floating slider carrying a magnetic head thereon; and
a dummy slider arranged facing the opposite side major surface of the disc-shaped recording medium so that dummy slider faces the floating slider with the disc-shaped recording medium in-between.

2. The recording/reproducing apparatus as recited in claim 1 further comprising:
head driving means for moving said floating slider substantially radially of said one major surface of the disc-shaped recording medium; and
dummy slider moving means for moving said dummy slider to a position facing said opposite side major surface of the disc-shaped recording medium and which is in register with the floating slider.

3. The recording/reproducing apparatus as recited in claim 1 wherein the disc-shaped recording medium has a thickness of 0.5 mm to 1.2 mm and a radius of curvature of not less than 20 m.

4. The recording/reproducing apparatus as recited in claim 1 wherein the disc-shaped recording medium is removable.
